(19) United States
(12) Patent Application Publication
(10) Pub. No.: US 2016/0341988 A1
(43) Pub. Date: Nov. 24, 2016

(54) LEAD STRUCTURE AND METHOD FOR PREVENTING AN ACF GLUE OVERFLOW INTO A DISPLAY AREA

(71) Applicant: SHENZHEN CHINA STAR OPTOELECTRONICS TECHNOLOGY CO.,LTD., Shenzhen, Guangdong (CN)

(72) Inventor: Chengliang YE, Shenzhen, Guangdong (CN)

(73) Assignee: Shenzhen China Star Optoelectronics Technology Co., Ltd., Shenzhen, Guangdong (CN)

(21) Appl. No.: 14/423,114

(22) PCT Filed: Jan. 5, 2015
(86) PCT No.: PCT/CN2015/070124

§ 371 Date: Feb. 21, 2015

(30) Foreign Application Priority Data
Nov. 5, 2014 (CN) 201410620885.5

(51) Int. Cl. G02F 1/1333

(52) U.S. Cl. CPC G02F 1/1333; G02F 2202/28

(57) ABSTRACT

A lead structure and a method for preventing an ACF glue overflowing into a display device, comprises a display panel and a circuit board, a lead is disposed between the display panel and the circuit board, where the lead comprises a plurality of longitudinal lines and lateral lines and the one longitudinal line is disposed between groups of the five lateral lines.

The lead structure and the method solve the issue which the ACF glue overflows into the display device and guarantee the image quality of the liquid crystal panel.

### FIELD OF THE INVENTION

The present invention relates to a field of manufacturing a liquid crystal display panel; in particular, to a method of bonding ACF (Anisotropic Conductive Film).

### BACKGROUND OF THE INVENTION

With the development of the electronic technology, people's daily life and work become increasingly dependent on electronic products. A liquid crystal display device is an important part of the electronic products and also closely affects people's experience, so it is particular important to improve the manufacturing method and the preparation process of the liquid crystal display device.

When the liquid crystal display panel connects with FPC (Flexible Printed Circuit) in the manufacturing process of the liquid crystal display panel, the connecting leads on the liquid crystal display panel and the connecting leads on the FPC are positioned accurately and then laminated by hot pressing. But the ACF glue is usually bonded on the FPC before hot pressing. Because the ACF glue has the conductive particles, the good conductivity is sure to exist between the FPC and the liquid crystal display device.

However, in the lead design method for the FPC, because the lead is arranged too closely, there is not buffer area after the ACF glue is hot pressed. The ACF glue overflows easily into the display area on the liquid crystal display panel to affect the display image of the liquid crystal display panel. Otherwise, in order to prevent the glue overflow phenomenon, the buffer area is designed to enlarge the distance between the leads. The lead cannot provide adequate supporting force for the ACF glue, and the ACF glue attaches directly to the LCD panel, resulting in excess glue. The ACF glue overflowing into the display area not only affects the image displayed by the liquid crystal display panel but also the lead is easy to be broken during the hot pressing process. It brings the unnecessary losses to the enterprise so it is very important to prevent the phenomenon of the overflow glue.

### SUMMARY OF THE INVENTION

A lead structure and a method are provided to solve the above mentioned technological problem that is a display image issue affected by an overflow glue phenomenon.

In order to achieve the above mentioned aim of the present invention, the present invention adopts the following solution:

A lead structure for preventing an ACF glue overflowing into a display area, comprising a display panel and a circuit board, a lead is disposed between the display panel and the circuit board, wherein the lead comprises a plurality of longitudinal lines and a plurality of lateral lines, each of the longitudinal lines is disposed between groups of the five or more successive lateral lines.

Further, one of the longitudinal lines is disposed between groups of the ten successive lateral lines and a buffer area is formed between the longitudinal line and the lateral line.

Further, each of the lateral line comprises an electrode, a substrate lead and a bending portion, the bending area being connected with the electrode and the substrate lead, so that the lateral line is step shape.

Further, the substrate lead is bonded on the display panel; an accommodating space is formed between the electrode and the display panel for containing photoresist.

Further, an overflow area is formed between the substrate lead and the circuit board.

Further, the longitudinal lines and the lateral lines are arranged alternately to show a lead arrangement being successive N shape or H shape.

A method for preventing an ACF glue overflowing into a display area, comprising the step of:

(1) arranging longitudinal lines and lateral lines between a display panel and a circuit board;

(2) disposing a photoresist on an accommodating space between the lateral line and the display panel;

(3) disposing a ACF glue between the lateral lines, the longitudinal lines and the circuit board.

Further, the display panel comprises a display area, and the display panel is a liquid crystal display panel or a touch panel.

Further, the circuit board is a flexible substrate.

Further, the photoresist is an OC photoresist.

The advantage of the present invention is that the present invention provides the lead structure and the method used for preventing the ACF glue from the display area. The method is easy and convenient to operate. When the liquid crystal display panel is laminated with a FPC by hot pressing, the present invention solves the issue of the overflowing ACF glue into the display area by the way of increasing the accommodating space and blocking off the ACF glue into the display area. It can ensure the image quality of the liquid crystal display panel and solve the display image loss affected by the overflow glue in the manufacture method.

### BRIEF DESCRIPTION OF THE DRAWINGS

FIG. 1 is a diagram of the embodiment of the present invention for preventing an ACF glue overflowing into a display area.

### DETAILED DESCRIPTION OF THE PREFERRED EMBODIMENTS

In order to better illustrate the technical characteristics and the structure of the present invention, the following in connection with preferred embodiments of the present invention, the detailed description and the accompanying drawings.

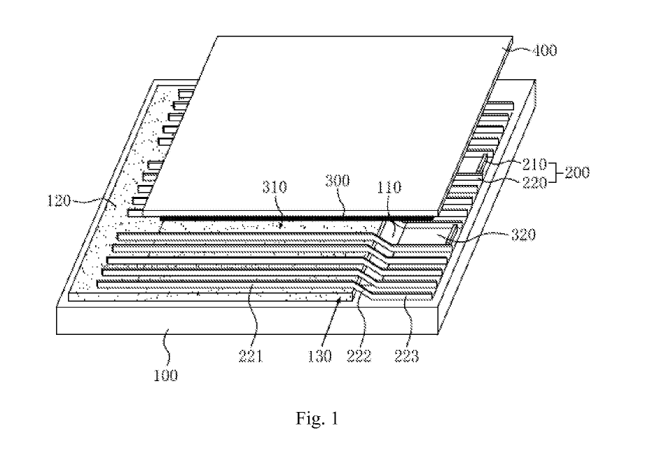

Refer to FIG. 1. The present invention provides a lead structure and a method used for preventing ACF glue overflowing into a display area. The lead structure comprises a display panel 100 and a circuit board 400, a lead 200 is disposed between the display panel 100 and a circuit board 400, where the lead 200 contains a plurality of longitudinal lines 210 and a plurality of lateral lines 220, each of the longitudinal lines 210 is disposed between groups of the five lateral lines 220. In the present embodiment, by considering the causes of density and supporting force of lead arrangement, the one longitudinal line 210 is disposed between groups of the ten lateral lines 220. A buffer area 310 is formed between the lateral lines 220 and the longitudinal line 210 to achieve the buffer area 310 containing the ACF glue 300 after pressing. At the same time, the present embodiment can block off the ACF glue 300 to prevent them from overflowing into the display area 110 so that the aim to prevent the ACF glue overflowing into the display area can be achieved. The method comprises the steps of:

(1) Dispose leads 200. A display area 110 is arranged on the display panel 100. A plurality of the leads 200, and the leads 200 comprises a plurality of longitudinal lines 210 and a plurality of lateral lines 220, where each of the longitudinal lines is disposed between groups of the ten lateral lines and a buffer area 310 is formed between the lateral lines 220 and the longitudinal lines 210. When the display panel 100 is laminated with the circuit board 400 by using a hot pressing process, the buffer area 310 is used for accommodating the pressed ACF glue 300. Because the traditional longitudinal arrangement is changed, the arrangement which the longitudinal lines 210 and the lateral lines 220 take turns is adopted in the present invention so as to increase the buffer area 310. The buffer area 310 is enough space to accommodate the pressed ACF glue 300 and the present invention guarantees the supporting force between the display 100 and the circuit 400.

(2) a photoresist 120 is accommodated between the lateral line 220 and the display panel 100. Each of the lateral lines 220 comprises an electrode 221, a substrate lead 223 and a bending portion 222, where the bending portion 222 connects with the electrode 221 and the substrate lead 223 and locates between the electrode 221 and the substrate lead 223 so that the lateral lead 220 is step shape. The substrate lead 223 is bonded on the display panel 100. The electrode is located higher than the substrate lead 223 and an accommodating space 130 is formed between the electrode 221 and the display panel 100 used for accommodating the photoresist 120. An overflow area 320 is formed between the substrate lead 223 and the circuit board 400.

(3) The ACF glue 300 is disposed among the lateral lead 220, the longitudinal lead 210 and the circuit board 400. When the display panel 100 is laminated with the circuit board 400 by using the hot pressing process, the buffer area 310 is used for accommodating the pressed ACF glue 300. The small part of the ACF glue 300 overflows into the overflow area 320. Because the lead structure 220 is step shape, the electrode 221 and the substrate lead 223 has the length difference to generate a blocking effect for the bending portion 222 and to prevent the ACF glue 300 from overflowing into the display area 110. When the ACF glue 300 could not be accommodated in the overflowing area 320, the excess ACF glue 300 would overflow outside. The ACF glue 300 on the side of the display panel 100 and the circuit board 400 can be cleaned by the clean device outside.

In the present invention, the photoresist 120 can be an OC photoresist, and the electrode 221 can be indium tin oxide. The display panel 100 is a liquid crystal display panel or a touch panel, and the circuit board 400 can be a flexible substrate.

In summary, the present invention provides the lead structure and the method used for preventing the ACF glue from overflowing into the display area. The method is easy and convenient to operate. When the liquid crystal display panel is laminated with a FPC by hot pressing, the present invention solves the issue of the overflowing ACF glue into the display area by the way of increasing the accommodating space and blocking off the ACF glue into the display area. It can ensure the image quality of the liquid crystal display panel and solve the display image loss affected by the overflow glue in the manufacture method.

Although reference to certain exemplary embodiments of the present invention is shown and described the present invention, those skilled in the art should understand that in the case without departing from the spirit and scope of the appended claims and their equivalents of the invention as defined next, in the form and details of the present invention, various changes.

What is claimed is:

1. A lead structure for preventing an ACF glue overflowing into a display area, comprising a display panel and a circuit board, a lead is disposed between the display panel and the circuit board, wherein the lead comprises a plurality of longitudinal lines and a plurality of lateral lines, each of the longitudinal lines is disposed between groups of the five or more successive lateral lines.

2. The lead structure for preventing an ACF glue overflowing into a display area as claimed in claim 1, wherein one of the longitudinal lines is disposed between groups of the ten successive lateral lines and a buffer area is formed between the longitudinal line and the lateral line.

3. The lead structure for preventing an ACF glue overflowing into a display area as claimed in claim 2, wherein each of the lateral line comprises an electrode, a substrate lead and a bending portion, the bending area being connected with the electrode and the substrate lead, so that the lateral line is step shape.

4. The lead structure for preventing an ACF glue overflowing into a display area as claimed in claim 3, wherein the substrate lead is bonded on the display panel, an accommodating space is formed between the electrode and the display panel for containing photoresist.

5. The lead structure for preventing an ACF glue overflowing into a display area as claimed in claim 4, wherein an overflow area is formed between the substrate lead and the circuit board.

6. The lead structure for preventing an ACF glue overflowing into a display area as claimed in claim 1, wherein the longitudinal lines and the lateral lines are arranged alternately to show a lead arrangement being successive N shape or H shape.

7. A method for preventing an ACF glue overflowing into a display area, comprising the step of:
(1) arranging longitudinal lines and lateral lines between a display panel and a circuit board;
(2) disposing a photoresist on an accommodating space between the lateral line and the display panel;
(3) disposing a ACF glue between the lateral lines, the longitudinal lines and the circuit board.

8. The method for preventing an ACF glue overflowing into a display area as claimed in claim 7, wherein the display panel comprises a display area, and the display panel is a liquid crystal display panel or a touch panel.

9. The method for preventing an ACF glue overflowing into a display area as claimed in claim 7, wherein the circuit board is a flexible substrate.

10. The method for preventing an ACF glue overflowing into a display area as claimed in claim 7, wherein the photoresist is an OC photoresist.
